(19) United States
(12) Patent Application Publication
(10) Pub. No.: US 2026/0277594 A1
(43) Pub. Date: Sep. 17, 2026

(54) SYSTEMS, METHODS, AND STORAGE MEDIA FOR SENSOR REMOTE FIRMWARE UPDATING BASED ON INTERNET OF THINGS (IOT) LARGE MODELS

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Jun WANG, Chengdu (CN); Lei HE, Chengdu (CN); Yunbai CHEN, Chengdu (CN)

(73) Assignee: CHENGDU QINCHUAN IOT TECHNOLOGY CO., LTD., Chengdu (CN)

(21) Appl. No.: 19/681,049

(22) Filed: May 18, 2026

(30) Foreign Application Priority Data
Apr. 21, 2026 (CN) 202610527350.6

(51) Int. Cl. G06F 8/65

(52) U.S. Cl. CPC G06F 8/65

(57) ABSTRACT

A system, a method, and a storage medium for sensor remote firmware updating based on a IoT large model are provided. The method comprises: determining a plurality of sensor update groups according to data characteristics of a plurality of sensors and geographic locations of the sensors in an industrial grid region; determining an update priority of each of the sensor update groups according to task characteristics and transmission characteristics of the sensor update groups; determining update parameters of the sensor update groups according to the update priority, firmware characteristics, and a channel state distribution; generating update instructions and a firmware update package according to the update parameters; and sending the update instructions and the firmware update package to a perception control platform, and controlling the plurality of sensors in the sensor update groups to perform firmware updating based on the update instructions.

### CROSS-REFERENCE TO RELATED APPLICATIONS

This application claims priority to Chinese Patent Application No. 202610527350.6, filed on Apr. 21, 2026, the entire contents of which are hereby incorporated by reference.

### TECHNICAL FIELD

The present disclosure relates to the technical field of the Internet of Things (IoT), and in particular to a system, a method, and a storage medium for sensor remote firmware updating based on an IoT large model.

### BACKGROUND

In an industrial IoT environment, a large number of sensor devices are widely deployed at operation sites. Remote upgrading and maintenance of firmware thereof are critical to ensuring system functionality and security. At present, mainstream upgrade solutions mostly adopt an indiscriminate full-image firmware push mode, which fails to fully consider spatial correlations among sensors and differences in task risk levels, and also lacks dynamic evaluation of real-time channel quality.

Meanwhile, conventional retransmission mechanisms are inefficient. In industrial network environments characterized by low bandwidth and high packet loss, network congestion is easily triggered, resulting in a high upgrade failure rate. Once an upgrade is interrupted, the system is often unable to implement breakpoint resume, and associated devices may simultaneously enter an upgrade state, thereby forming a sensing blind area and posing safety risks to industrial production.

Accordingly, it is desirable to provide a system, a method, and a storage medium for sensor remote firmware updating based on an IoT large model, so as to achieve safety, reliability, and continuity of large-scale sensor firmware upgrades under complex industrial network conditions.

### SUMMARY

One or more embodiments of the present disclosure provide a system for sensor remote firmware updating based on an Internet of Things (IoT) large model, comprising a sensor management platform. The sensor management platform is configured to: determine a plurality of sensor update groups according to data characteristics of a plurality of sensors and geographic locations of the plurality of sensors in an industrial grid region; determine an update priority of each of the plurality of sensor update groups according to task characteristics and transmission characteristics of the plurality of sensor update groups; determine update parameters of the plurality of sensor update groups according to the update priority, firmware characteristics, and a channel state distribution; generate update instructions and a firmware update package according to the update parameters, wherein the update instructions include an update time; and send the update instructions and the firmware update package to a perception control platform, and control the plurality of sensors in the plurality of sensor update groups to perform firmware updating based on the update instructions.

One or more embodiments of the present disclosure provide a method for sensor remote firmware updating based on an Internet of Things (IoT) large model, implemented by a sensor management platform of a system for sensor remote firmware updating based on the IoT large model. The method comprises: determining a plurality of sensor update groups according to data characteristics of a plurality of sensors and geographic locations of the plurality of sensors in an industrial grid region; determining an update priority of each of the plurality of sensor update groups according to task characteristics and transmission characteristics of the plurality of sensor update groups; determining update parameters of the plurality of sensor update groups according to the update priority, firmware characteristics, and a channel state distribution; generating update instructions and a firmware update package according to the update parameters, wherein the update instructions include an update time; and sending the update instructions and the firmware update package to a perception control platform, and controlling the plurality of sensors in the plurality of sensor update groups to perform firmware updating based on the update instructions.

One or more embodiments of the present disclosure provide a non-transitory computer-readable storage medium. The storage medium stores computer instructions that, when read by a computer, cause the computer to executes a method for sensor remote firmware updating based on an IoT large model.

### BRIEF DESCRIPTION OF THE DRAWINGS

The present disclosure will be further elucidated by way of exemplary embodiments, which are described in detail with reference to the accompanying drawings. These embodiments are not limiting. In these embodiments, the same reference numerals denote the same structures, wherein:

FIG. 1 is an exemplary structural diagram illustrating a system for sensor remote firmware updating based on an IoT large model according to some embodiments of the present disclosure;

FIG. 2 is a flowchart illustrating an exemplary process of a method for sensor remote firmware updating based on an IoT large model according to some embodiments of the present disclosure;

FIG. 3 is an exemplary schematic diagram illustrating processing of update sub-data blocks according to some embodiments of the present disclosure; and

FIG. 4 is a schematic flowchart illustrating adjustment of update times of sensor update groups according to some embodiments of the present disclosure.

### DETAILED DESCRIPTION

To more clearly illustrate the technical solutions of the embodiments of the present disclosure, the accompanying drawings to be used in the description of the embodiments will be briefly described below. Obviously, the accompanying drawings in the following description are only some examples or embodiments of the present disclosure, and that the present disclosure may be applied to other similar scenarios in accordance with these drawings without creative labor for those of ordinary skill in the art. Unless obviously acquired from the context or the context illustrates otherwise, the same numeral in the drawings refers to the same structure or operation.

It should be understood that “system,” “device,” “unit,” and/or “module” as used herein is a way to distinguish between different components, elements, parts, sections, or assemblies at different levels. However, these words may be replaced by other expressions if they accomplish the same purpose. The term “and/or”, as used herein, is merely a way of describing the associative relationship of an associated object, indicating that three relationships may exist, e.g., A and/or B, which may be represented as: A alone, both A and B, and B alone.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

Furthermore, if the description of the embodiments in the present disclosure involves descriptions such as “first” and “second,” then these descriptions are for descriptive purposes only and are not to be construed as indicating or implying relative importance or implicitly specifying the quantity of the indicated technical features. Thus, features defined by “first” or “second” may explicitly or implicitly include at least one such feature.

Flowcharts are used in the present disclosure to illustrate the operations performed by the system according to some embodiments of the present disclosure. It should be understood that the operations described herein are not necessarily executed in a specific order. Instead, they may be executed in reverse order or simultaneously. Additionally, one or more other operations may be added to these processes, or one or more operations may be removed.

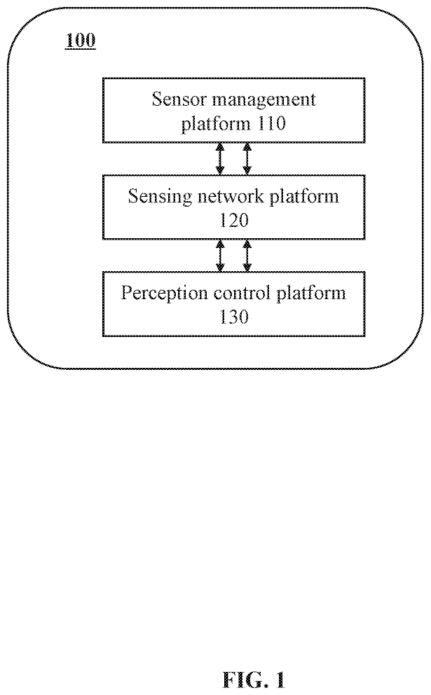

FIG. 1 is an exemplary structural diagram illustrating a system for sensor remote firmware updating based on an IoT large model according to some embodiments of the present disclosure. In some embodiments, the system 100 for sensor remote firmware updating based on the IoT large model may include a sensor management platform 110, a sensing network platform 120, and a perception control platform 130.

The sensor management platform 110 refers to an integrated management platform configured to manage, coordinate, and orchestrate communications and collaboration among multiple platforms. In some embodiments, the sensor management platform 110 is configured as a server or a processor. In some embodiments, the sensor management platform 110 performs bidirectional data interaction with the sensing network platform 120.

In some embodiments, the sensor management platform 110 includes a data center. The data center is configured to store data, information, instructions, or the like generated by or received by the sensor management platform 110. The data center includes a model library. The sensor management platform 110 may invoke various models from the model library, such as machine learning models, computational models, large language models, or the like.

In some embodiments, the sensor management platform 110 performs data interaction with the sensing network platform 120 through the data center.

In some embodiments, the sensor management platform 110 is configured to execute a method for sensor remote firmware updating. For example, the sensor management platform 110 may execute the steps of a process 300 and/or a process 400.

The sensing network platform 120 refers to a platform configured to comprehensively manage sensing information. In some embodiments, the sensing network platform 120 is configured as a communication network or a gateway. In some embodiments, the sensing network platform 120 is configured to perform data interaction with the sensor management platform 110 and the perception control platform 130, respectively.

The perception control platform 130 refers to a platform configured to generate sensing information and execute regulation and control instructions. In some embodiments, the perception control platform 130 is provided with a communication device, a control device, sensors, a positioning device, or the like. The perception control platform 130 performs bidirectional data interaction with the sensing network platform 120. The sensors include various monitoring sensors deployed in an industrial region, such as temperature and humidity sensors, gas sensors, image sensors, status and motion sensors, and security sensors (e.g., smoke detectors and door magnetic sensors).

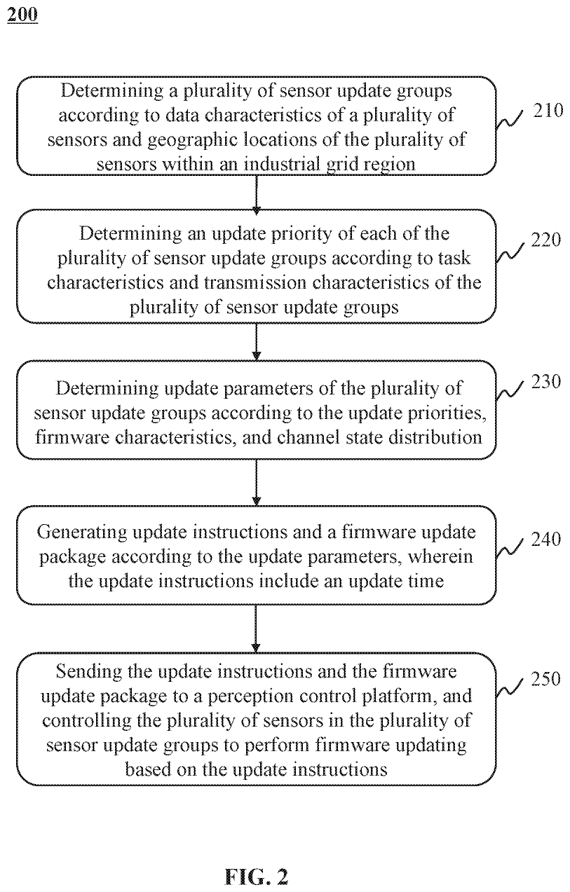

For further description of the foregoing, reference may be found in FIGS. 2-4 and the related descriptions thereof.

In some embodiments of the present disclosure, by means of the system 100 for sensor remote firmware updating based on the IoT large model, an information operation closed loop may be formed among the functional platforms. Under unified management of the sensor management platform, coordinated and regular operation can be achieved, thereby enabling continuous and reliable execution of sensor remote firmware update tasks and improving the informatization and intelligence level of remote firmware updating.

It should be noted that the foregoing description of the system 100 for sensor remote firmware updating based on the IoT large model is provided for convenience of description only and does not limit the present disclosure to the scope of the illustrated embodiments. It may be understood by those skilled in the art that, after understanding the principles of the system, various platforms may be combined in any suitable manner, or subsystems may be formed and connected with other modules, without departing from such principles.

FIG. 2 is a flowchart illustrating an exemplary process of a method for sensor remote firmware updating based on an IoT large model according to some embodiments of the present disclosure. In some embodiments, a process 200 may be executed by the sensor management platform 110 or a processor. As shown in FIG. 2, the process 200 may include the following steps:

Step 210: determining a plurality of sensor update groups according to data characteristics of a plurality of sensors and geographic locations of the plurality of sensors within an industrial grid region.

A sensor refers to a device configured to collect physical quantities or environmental information and convert the same into processable signals. For example, the sensor may include various types for collecting data such as temperature, pressure, video, humidity, or the like. The sensors are deployed at various locations within an industrial region according to data acquisition requirements.

Data characteristics refer to attribute information describing data generation and transmission behaviors of sensors. The data characteristics may be used to distinguish roles undertaken by the sensors in an overall data acquisition task and demands for network resources. The roles may include, for example, types of collected data and responsible location regions. For example, the data characteristics may include a data acquisition type, a data acquisition frequency, a data upload frequency, and a single-upload data volume.

In some embodiments, the sensor management platform may obtain the data characteristics of each sensor based on a configuration information database of the sensors. The configuration information database of the sensors is a dynamic database recording various configuration information of the sensors, and may include identity information and basic attributes, hardware and software configurations, physical installation locations, network topology relationships, status and upgrade information, or the like of the sensors.

In some embodiments, the data characteristics may further be obtained from configuration information directly reported by the sensors.

The industrial grid region refers to a geographic region formed by partitioning an industrial region. The industrial grid region may include a plurality of grid regions. For example, the industrial grid region may be partitioned according to an industrial production process, an operation type, or the like. As another example, the industrial grid region may be formed as a gridded region based on sensor distribution. In some embodiments, the industrial grid region may be defined according to actual requirements.

In some embodiments, the industrial grid region may reflect geographic partitioning of sensors within the industrial region. In some embodiments, the industrial region may be divided into grids, each grid corresponding to a region code. The sensor management platform may manage geographic locations of the sensors based on region codes of the grids in which the sensors are located.

The geographic location characterizes a deployment position of a sensor within the industrial grid region. For example, the geographic location may include an installation position and a spatial relationship. The geographic location of a sensor may be represented by longitude and latitude coordinates, an installation address (e.g., “west air compressor room of Workshop No. 3 of XX Factory”), or a region code of the grid region within the industrial grid region to which the sensor corresponds.

In some embodiments, the sensor management platform may obtain the geographic location of a sensor through a GPS module integrated within the sensor. In some embodiments, the geographic location may further be determined through cellular network base station positioning or a preset deployment list.

In some embodiments, the sensor management platform may determine the geographic location of a sensor based on the region code of the grid region within the industrial grid region to which the sensor corresponds. For example, the geographic location of each grid region within the industrial grid region may be determined in advance and stored in association with the region code.

A sensor update group refers to a set of sensors partitioned for coordinated updating. For example, one sensor update group may include sensors of different data acquisition types that are classified into the same group for coordinated updating.

Coordinated updating refers to updating multiple sensors sequentially, dynamically, and intelligently according to a predetermined order. Coordinated updating is distinguished from an isolated update of a single sensor or a simultaneous update of all sensors.

Coordinated updating enables multi-sensor coordination and update management from multiple dimensions, such as time, resources, environment, and status, in a refined manner, thereby ensuring service continuity, optimizing upgrade paths, avoiding resource waste, and allowing update strategies to be dynamically adjusted and optimized according to tasks and environments.

In some embodiments, the process of determining the plurality of sensor update groups includes the following steps:

First, the sensor management platform performs geographic partitioning of all sensors based on the industrial grid regions.

In some embodiments, the sensor management platform may perform geographic partitioning of all sensors according to region codes of respective grid regions within the industrial grid region. For example, region codes of all grid regions within the industrial grid regions may be evenly divided into multiple groups in a code order, each group corresponding to one geographic partition.

In some embodiments, the sensor management platform may determine geographic partitions according to distribution conditions of respective grid regions within the industrial grid region. For example, grid regions adjacent to a specific grid region within the industrial grid region may be classified into one geographic partition. The count of grid regions within one geographic partition may be a preset count, such as 4, 6, 9, or the like.

Second, within each geographic partition, the sensor management platform sorts the sensors according to data characteristics thereof based on a sorting rule, thereby generating a sensor list. For example, the sorting rule may be set as follows: a first priority is a data acquisition type, a second priority is a data acquisition frequency, and a third priority is a sensor ID. Sorting according to the data acquisition type may be performed based on a preset type sequence, such as temperature-pressure-video. Sorting according to the data acquisition frequency may be performed in descending order or ascending order of the acquisition frequency. Sorting according to the sensor ID may be performed according to an ID numbering sequence. The sensors in the sensor list are presented in the sorted order.

Third, the sensor management platform performs round-robin allocation within each geographic partition based on the sensor list to determine sensor groupings. The round-robin allocation includes: setting a target count of sensor groups as K; initializing K empty sensor groups; and then traversing the sorted sensor list and assigning an i-th sensor to a group having a group number of (i mod K)+1, thereby ultimately obtaining K sensor groups. Here, (i mod K) represents a remainder obtained by dividing i by K, with a result ranging from 0 to K−1, and adding 1 maps the result to group numbers 1 to K.

Finally, the sensor management platform merges sensor grouping results obtained for all geographic partitions through the foregoing steps, thereby forming a plurality of sensor update groups. For example, assuming that there are M geographic partitions within the industrial grid regions and each geographic partition includes K sensor groups, the count of merged sensor update groups is K. Exemplarily, the K sensor update groups finally determined from the M geographic partitions are as follows:

Sensor update group 1:[Partition 1_Group_1, Partition 2_Group_1, . . . , Partition M_Group_1]; Sensor update group 2:[Partition 1_Group_2, Partition 2_Group_2, . . . , Partition M_Group_2]; . . . ; Sensor update group K: [Partition 1_Group_K, Partition 2_Group_K, . . . , Partition M_Group_K].

Here, M represents a partition number of a geographic partition, K represents a group number of each sensor group within each geographic partition, and Partition M_Group_K represents a K-th sensor group within a geographic partition M.

In some embodiments, the sensor update groups may also be determined in various other manners. For example, the sensor update groups may be determined according to connection relationships of the sensors in a network topology.

In some embodiments, the sensor management platform determines association degrees among the plurality of sensors based on the data characteristics and subtask characteristics of the plurality of sensors; and adjusts the plurality of sensor update groups based on the association degrees.

In some embodiments, the sensor management platform determines the association degrees among the plurality of sensors based on the data characteristics and the subtask characteristics of the plurality of sensors through multiple approaches.

The sub-task characteristic of a sensor reflect importance attributes of a data acquisition task undertaken by the sensor or importance attributes of a local region in which the sensor is deployed. The sub-task characteristic of a sensor constitute a part of the task characteristics of a sensor update group. The task characteristics describe overall task importance of a sensor update group, the sub-task characteristic of a senso represents a task priority of the sensor itself or within a specific subsystem or micro-environment.

In some embodiments, the sensor management platform may determine corresponding sub-task characteristics by querying a preset table. For further description regarding determination of the task characteristics and the sub-task characteristics, reference may be made to the related description of Step 220.

An association degree refers to an index for quantifying functional coupling, logical dependency, or collaborative working association strength between any two or more sensors. For example, the higher the association degree, the are more likely that the sensors jointly constitute a critical functional unit. Failure or abnormality of one sensor may affect performance of other associated sensors and may even lead to failure of an entire monitoring or control chain.

In some embodiments, the sensor management platform determines attribute vectors formed by task characteristics and data types of respective sensors, calculates a similarity between attribute vectors of any two sensors, and determines the similarity as the association degree. For example, the attribute vectors may be obtained by vectorizing the data characteristics and the sub-task characteristics. Manner for determining the imilarity include cosine similarity, a Pearson correlation coefficient, a Jaccard similarity coefficient, or the like.

In some embodiments, the association degrees among the plurality of sensors may further be determined through a graph neural network model. For example, the sensors are taken as nodes of a graph; geographic distances between sensors, data interaction frequencies, proportions of jointly executed tasks, or the like are taken as initial edge features; and the graph is input into a trained graph convolutional network (GCN) to output association degrees between nodes (i.e., between sensors).

In some embodiments, the association degrees among the plurality of sensors may further be determined in various other manners. For example, the association degrees may be determined through statistical analysis based on historical collaborative working patterns or the like.

In some embodiments, the sensor management platform adjusts the plurality of sensor update groups based on the association degrees.

In some embodiments, the sensor management platform performs geographic partitioning of all sensors based on the industrial grid region, and then, for sensors within each geographic partition, independently and in parallel performs update group allocation based on the association degrees, so as to adjust the plurality of sensor update groups.

For further details regarding geographic partitioning, reference may be made to the foregoing related description.

In some embodiments, independently and in parallel performing update group allocation includes the following steps:

First, within each geographic partition, a preset count (K) of empty sensor update groups are initialized, and pairwise similarities of attribute vectors of all sensors within the geographic partition are calculated to form a similarity matrix. In some embodiments, prior to calculating the similarities, the attribute feature vectors may be preprocessed, for example, by normalization.

Then, an iterative greedy allocation strategy is adopted to reassign the sensors. A condition for reassignment is that there still exist unassigned sensors within the current geographic partition. For each geographic partition, a sensor having a highest average similarity with existing groups among currently unassigned sensors is selected, and the selected sensor is assigned to a target group having a lowest similarity thereto, until all sensors are assigned. The existing groups refer to groups to which sensors have already been assigned. An average similarity of an existing group is an average of pairwise attribute vector similarities among sensors within the group.

Finally, sensor groups having corresponding group numbers in all geographic partitions are merged to form final global sensor update groups.

For example, assuming there are two geographic partitions 1 and 2. Sensor groupings in geographic partition 1 are: Partition 1—Update Group 1—[Sensor 1, Sensor 2, Sensor 3]; Partition 1—Update Group 2—[Sensor 4, Sensor 5]. Sensor groupings in geographic partition 2 are: Partition 2—Update Group 1—[Sensor 6, Sensor 7]; Partition 2—Update Group 2—[Sensor 8, Sensor 9].

Then, the merged final sensor update groups include: Sensor Update Group 1—[Sensor 1, Sensor 2, Sensor 3, Sensor 6, Sensor 7]; and Sensor Update Group 2—[Sensor 4, Sensor 5, Sensor 8, Sensor 9].

In some embodiments, adjustment of the sensor update groups may further be implemented by means of hierarchical clustering and optimization algorithms. For example, the sensor management platform may first perform hierarchical clustering on all sensors based on their association degrees to form a clustering tree. Then, according to the preset count K of sensor update groups, pruning is performed at different levels of the clustering tree to form K initial sensor update groups.

In some embodiments, adjustment of the sensor update groups may further be implemented in various other manners. For example, a solution manner based on a multi-objective optimization problem (such as an NSGA-II algorithm) may be used to dynamically adjust the sensor update groups.

In some embodiments of the present disclosure, update task allocation is optimized by dynamically grouping sensors based on the data characteristics and the sub-task characteristics of the sensors and the association degrees among the sensors. In this way, sensors with weak coupling may be updated in parallel, thereby reducing conflicts and resource consumption and improving efficiency. Meanwhile, fault isolation capability is enhanced, such that when some sensors fail, continuity of critical tasks is ensured, thereby improving system reliability and response speed.

Step 220: determining an update priority of each of the plurality of sensor update groups according to task characteristics and transmission characteristics of the plurality of sensor update groups.

The task characteristics reflect attributes of task importance undertaken by a sensor update group or importance of a deployment region thereof. For example, the task characteristics may reflect a priority of sensors within the sensor update group for monitoring critical equipment, or a criticality level of the grid region in which the sensors are located.

In some embodiments, the sensor management platform determines the sub-task characteristics of the sensors by querying a first preset table according to the task types and the geographic locations of the sensors. The first preset table may be preset based on experience and store a plurality of different task types and different geographic locations of sensors, and corresponding sub-task characteristics of the sensors.

In some embodiments, the sub-task characteristics may further be determined by analyzing historical alarm records of the respective sensors.

The task characteristic of a sensor update group may be determined based on the sub-task characteristics of all sensors within the sensor update group. For example, the sensor management platform may calculate an average importance value corresponding to the sub-task characteristics of the respective sensors in a sensor update group as the task characteristic of the sensor update group.

The transmission characteristics refer to parameters for measuring stability of a communication channel of a sensor. For example, the transmission characteristics may be measured by parameters such as a signal-to-noise ratio (SNR), a packet loss rate, a bandwidth utilization rate, and a round-trip time (RTT).

In some embodiments, the sensor management platform determines transmission characteristics of a sensor by querying a second preset table according to parameters such as the signal-to-noise ratio (SNR), the packet loss rate, the bandwidth utilization rate, and the round-trip time (RTT). The second preset table may store multiple sets of different parameter combinations of SNR, packet loss rate, bandwidth utilization rate, RTT, and corresponding transmission characteristics.

In some embodiments, the sensor management platform may quantify transmission stability into different levels based on parameters such as SNR, packet loss rate, bandwidth utilization rate, and RTT, and use the levels as the transmission characteristics.

The update priority refers to a quantitative indicator for sorting update sequences of the sensor update groups. For example, a higher numerical value of the update priority may indicate that an update batch of the corresponding sensor update group is arranged later.

In some embodiments, determining the update priority includes mapping quantified values of the task characteristics and the transmission characteristics of each sensor update group to a unified numerical interval (for example, 0 to 1), and then determining the update priority P through weighting. For example, a weighted calculation formula may be: P=weight1 ×(1−task characteristic)+weight2 ×transmission characteristic. Here, weight 1 is typically a negative value. The more critical the task, the lower the value of P and the higher the update priority. The more stable the transmission, the higher the value of P and the lower the update priority.

In some embodiments, the sensor management platform may determine the update priority by using a trained machine learning model based on the task characteristics and the transmission characteristics of the sensor update groups.

In some embodiments, the update priority may further be determined in various other manners. For example, the update priority may be derived through a fuzzy logic inference system based on multiple input features.

Step 230: determining update parameters of the plurality of sensor update groups according to the update priorities, firmware characteristics, and a channel state distribution.

The firmware characteristics refer to data describing a size of a firmware update package. For example, the firmware characteristics may be represented by a volume of the firmware update package, with units such as KB or MB.

In some embodiments, the sensor management platform may directly query a size of the firmware update package from a firmware version management server to obtain the firmware characteristics. For example, the system may store size information of firmware packages of different versions. In some embodiments, the firmware characteristics may further be obtained by analyzing file metadata of the firmware update package to determine the size of the firmware update package.

The channel state distribution refers to a pattern characteristic of variation in quality conditions of a communication channel over time. For example, the channel state distribution may include statistical data of signal-to-noise ratio (SNR), packet loss rate, and bandwidth utilization rate within a preset time period.

In some embodiments, the channel state distribution may be obtained through statistical data such as SNR, packet loss rate, and bandwidth utilization rate within a preset time period (for example, 24 hours). For example, the sensor management platform may periodically collect such statistical data from a network monitoring system and perform trend analysis to determine the channel state distribution.

In some embodiments, the channel state distribution may further be obtained through analysis of historical communication logs.

The update parameters refer to operational or scheduling configuration information guiding execution of firmware updates. For example, the update parameters include an update batch and an update time.

In some embodiments, determining the update parameters includes the following steps:

First, the sensor management platform sorts all sensor update groups according to calculated update priority values, and then merges groups having similar update priorities into a same update batch. Similar update priorities may include update priorities falling within a same priority interval, and the priority interval may be preset.

Then, for each update batch, the sensor management platform selects a most appropriate update time based on a total firmware package size of all sensor update groups in the update batch and the channel state distribution corresponding to the update batch. For example, for a batch requiring transmission of a large amount of data, the sensor management platform may schedule the update time during a period such as early morning when bandwidth is sufficient and packet loss rate is low, based on channel state distribution data.

In some embodiments, the sensor management platform may determine the update parameters by using an optimization algorithm. For example, update efficiency and network load balancing may be taken as optimization objectives, and a genetic algorithm may be adopted to calculate an optimal update batch division and an update time for each batch.

In some embodiments, the update parameters may further be determined in various other manners. For example, the update strategy may be dynamically adjusted based on real-time network load.

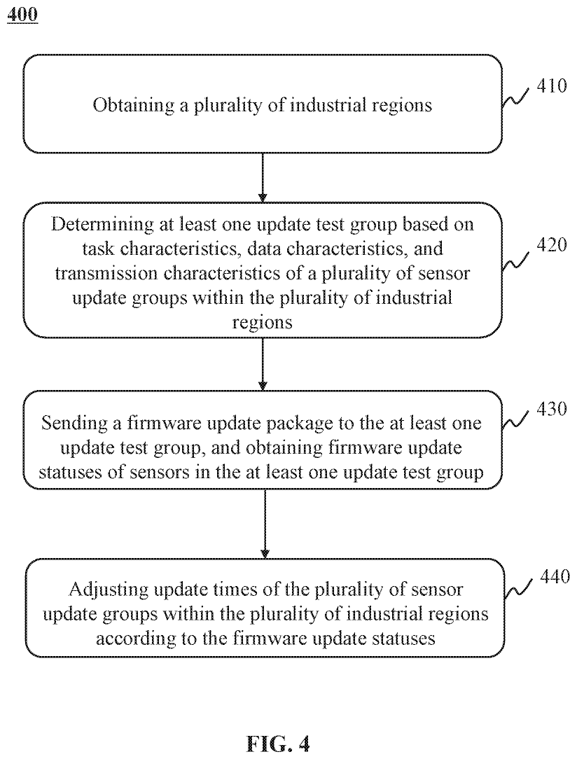

In some embodiments, the sensor management platform may determine at least one update test group and adjust update times of a plurality of sensor update groups in a plurality of industrial regions based on firmware update statuses of a plurality of sensors in the at least one update test group. For further details, reference may be made to FIG. 4 and the related description thereof.

Step 240: generating update instructions and a firmware update package according to the update parameters, wherein the update instructions include an update time.

The update instructions refer to a set of commands and parameters required to execute a firmware update. For example, the update instructions may include information such as a target sensor ID to be updated, an update time, and a check code.

The update time refers to a specified time point or time window for initiating a firmware update process. For example, a sensor node may synchronously initiate a firmware update procedure upon reaching a preset update time.

In some embodiments, the sensor management platform generates an instruction file including information such as the update time, the target sensor ID to be updated, and the check code by filling a pre-provided instruction template according to the determined update parameters. For example, placeholders may be reserved in the instruction template, and the sensor management platform replaces the placeholders with the update time, the target sensor to be updated, and the check code corresponding to a current update task to generate the update instructions.

The firmware update package refers to a file including data required for updating firmware of a sensor. For example, the firmware update package may be a differential package representing a difference between an old-version firmware and a new-version firmware.

In some embodiments, generating the firmware update package by the sensor management platform includes: acquiring binary files of the old-version firmware and the new-version firmware from a firmware version management server, and then calculating a binary difference therebetween by using a differential algorithm (for example, a BsDiff algorithm), thereby generating a differential package as the firmware update package.

In some other embodiments, the firmware update package may alternatively be a complete firmware image file. For example, when a current firmware version of a sensor is too old to support differential updating, the sensor management platform may directly generate and deliver a complete firmware update package.

Step 250: sending the update instructions and the firmware update package to a perception control platform, and controlling the plurality of sensors in the plurality of sensor update groups to perform firmware updating based on the update instructions.

In some embodiments, the perception control platform may receive the update instructions and the firmware update package sent by the sensor management platform, and transmit the update instructions and the firmware update package to corresponding sensors. For example, the sensor management platform may send the generated update instructions and firmware update package to a corresponding perception control platform via a secure communication protocol (for example, MQTT or HTTPS). The perception control platform, serving as a gateway or proxy, is responsible for further distributing the update instructions and the firmware update package to a plurality of sensors managed thereby according to sensor IDs.

In some embodiments, the perception control platform controls the sensors to perform firmware updating based on the update instructions and the firmware update package. For example, the perception control platform parses the update instructions, and delivers the firmware update package to the sensors according to the update time specified in the update instructions, thereby controlling the sensors to perform firmware updating at the update time. After receiving the instruction, a communication module of a sensor node triggers a firmware upgrade daemon process. The process parses the update instruction, synchronizes an internal clock of the sensor node with a timestamp therein, and causes the sensor node to enter a ready state to wait for arrival of a designated time. Upon reaching the update time, the sensor node initiates a firmware update procedure, including acquiring the firmware update package from a local cache or a gateway, performing integrity verification, writing to a storage area, and executing a restart.

In some embodiments, the sensors may periodically poll the perception control platform to determine whether a new firmware version is available. Once a new version is detected, the sensors may actively download the firmware update package and perform the firmware updating according to the update time and other information defined in the update instructions.

In some embodiments, the sensor management platform divides the firmware update package into a plurality of update sub-data blocks according to a preset unit size and sends the plurality of update sub-data blocks to the perception control platform. The plurality of update sub-data blocks are transmitted to each of a plurality of sensors via the perception control platform. The sensor management platform obtains first bitmap indices returned by the plurality of sensors, wherein each of the first bitmap indices reflects first reception states of the plurality of update sub-data blocks for a corresponding sensor; and retransmit one or more of the plurality of update sub-data blocks to at least one of the plurality of sensors based on the first bitmap indices.

The preset unit size refers to a predefined basic unit for dividing the firmware update package. For example, the preset update unit size may be 512 bytes or 1 KB. The preset update unit size may be predetermined based on experience.

The update sub-data blocks refer to data fragments obtained by sequentially segmenting the firmware update package according to the preset unit size. For example, the update sub-data blocks are a plurality of small data fragments formed by cutting the complete firmware update package according to the preset unit size, and each small data fragment constitutes one update sub-data block.

In some embodiments, the sensor management platform loads the received complete firmware update package into memory, and then sequentially reads data from a starting position of the firmware update package according to the preset unit size (for example, 512 bytes or 1 KB), and encapsulates each data segment reaching the preset unit size into an independent update sub-data block. If remaining data of the firmware update package is less than one preset unit size, the sensor management platform pads the remaining data with specific padding bytes (for example, 0×00) to reach the preset unit size, thereby forming a last update sub-data block.

The firmware update package may also be divided in various other manners, for example, based on a file system block size, or dynamically adjusted according to a network maximum transmission unit (MTU).

In some embodiments, the sensor management platform may transmit the divided update sub-data blocks to the perception control platform via a network transmission protocol. During transmission, a sequence number and total block count information of each update sub-data block may be attached, so that a receiving end may perform ordering and integrity verification. Then, the perception control platform transmits the plurality of update sub-data blocks to corresponding sensors. Each sensor among the plurality of sensors receives a plurality of corresponding update sub-data blocks.

In some embodiments, the sensor management platform obtains a plurality of first bitmap indices returned by a plurality of sensors, wherein each of the first bitmap indices reflects first reception states of the plurality of update sub-data blocks for a corresponding sensor.

A first bitmap index is a binary bit sequence that reflects first update states of update sub-data blocks for a single sensor. Each bit in the binary bit sequence reflects a first reception state of a corresponding update sub-data block. For example, the first bitmap index may reflect whether the single sensor successfully receives a plurality of update sub-data blocks.

The first reception state refers to a reception status of a single sensor with respect to an update sub-data block. The first reception state may be represented by 0 or 1, where 0 indicates that the sensor fails to receive the update sub-data block, and 1 indicates that the reception is successful.

In some embodiments, after receiving an update sub-data block, the sensor performs an integrity check (e.g., cyclic redundancy check (CRC) or hash verification) on each data block to determine the first reception state. If the integrity check indicates data loss or absence of data, the first reception state is set to 0.

The sensor maintains a local first bitmap index. Each bit in the binary bit sequence of the first bitmap index corresponds to one update sub-data block. If an update sub-data block is successfully received and passes verification, the corresponding bit is set to 1; otherwise, the bit is set to 0.

In some embodiments, the first bitmap index may be implemented as a binary array or a linked list, wherein each position or node corresponds to an index number of a sub-update package and records a reception and verification status of the sub-update package. The first bitmap index may be determined using various data structures and processing logics.

In some embodiments, after completing reception of a certain count of update sub-data blocks or upon reaching a preset time interval, the sensor generates the first bitmap index and packages and uploads the first bitmap index to the perception control platform, which then forwards it to the sensor management platform.

In some embodiments, the sensor management platform generates a plurality of sub-update packages for the plurality of update sub-data blocks. The plurality of sub-update packages are used to determine the first bitmap indices.

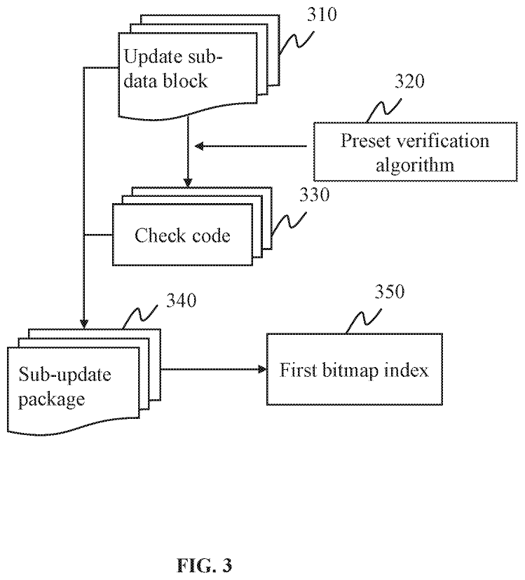

FIG. 3 is an exemplary schematic diagram illustrating processing of update sub-data blocks according to some embodiments of the present disclosure.

In some embodiments, as shown in FIG. 3, for each of a plurality of update sub-data blocks 310, the sensor management platform determines a corresponding check code 330 based on the update sub-data block 310 through a preset verification algorithm 320; generates a plurality of sub-update packages 340 according to the plurality of update sub-data blocks 310 and the plurality of check codes 330; and determines a first bitmap index 350 based on the plurality of sub-update packages 340.

The verification algorithm refers to an algorithm used to detect whether errors occur during data transmission. For example, the verification algorithm may be a cyclic redundancy check (CRC) algorithm.

In some embodiments, the preset verification algorithm is uniformly configured in advance on the sensor management platform and the perception control platform.

The check code refers to a short binary sequence obtained by calculation through the verification algorithm and used to verify data integrity of the update sub-data blocks. In some embodiments, one update sub-data block corresponds to one check code.

In some embodiments, the sensor management platform uses a update sub-data block as an input and calculates a fixed-length binary sequence through the preset verification algorithm as the check code for the update sub-data block. For example, a cyclic redundancy check (CRC) algorithm may be used to calculate a fixed-length CRC check code by taking the update sub-data block as an input. As another example, the verification algorithm may alternatively adopt an MD5 or SHA-256 hash algorithm.

In some embodiments, the sensor management platform generates sub-update packages based on the update sub-data blocks and the check codes.

A sub-update package refers to a structured data packet unit including the update sub-data block and additional information for ensuring transmission reliability and correct sequencing. The additional information may include the check code.

In some embodiments, in order to generate the sub-update package, the sensor management platform assigns a unique index number to each update sub-data block, and combines the unique index number with the update sub-data block itself and the corresponding check code to obtain a sub-update package corresponding to the update sub-data block.

For example, the sensor management platform may concatenate the index number, the update sub-data block, and the check code in a specific order to form a complete sub-update package. As another example, the sub-update package may be in a format of a general data packet protocol, including a packet header (including the index number), a payload area (including the update sub-data block), and a packet tail (including the check code).

In some embodiments, the sub-update package may further include other additional information, such as a version number, a timestamp, or encryption information.

In some embodiments, the sensor management platform sends the plurality of sub-update packages one by one to a corresponding perception control platform.

In some embodiments, after the perception control platform transmits the plurality of sub-update packages to corresponding sensors, each sensor internally determines the first bitmap index according to information contained in the sub-update packages.

For example, after each sensor receives the plurality of corresponding sub-update packages, the sensor first extracts the update sub-data blocks and the check codes therein, and performs verification on the received update sub-data blocks by using the same preset verification algorithm as that used by the sensor management platform.

If the verification result is consistent, the index number corresponding to the sub-data block is marked as successfully received, and a corresponding position in the binary bit sequence of the first bitmap indiex is set to 1. If the verification result is inconsistent, the index number is marked as missing or erroneous, and the corresponding position is set to 0.

In some embodiments of the present disclosure, by generating a check code for each update sub-data block and encapsulating the check code into a sub-update package for transmission, data transmission integrity is ensured. The solution can effectively detect silent errors and significantly improve reliability of firmware updates. Meanwhile, the sensors can accurately construct the first bitmap index, thereby laying a foundation for highly reliable selective retransmission and further ensuring stability and efficiency of system updates.

In some embodiments, the sensor management platform retransmits one or more of the plurality of update sub-data blocks to at least one of the plurality of sensors based on the first bitmap indices by the at least one of the plurality of sensors. In some embodiments, the sensor management platform receives and parses the first bitmap indices from the sensors, identifies all index positions with bit values of 0, and forms a missing index list. The index positions with bit values of 0 correspond to update sub-data blocks that have not been successfully received by the sensors. According to the missing index list, the sensor management platform searches and identifies corresponding update sub-data blocks from a local cache, repackages the update sub-data blocks requiring retransmission, and sends the update sub-data blocks requiring retransmission to the corresponding sensors.

In some embodiments, additional metadata (e.g., a retransmission count or a timestamp) may be carried during retransmission to facilitate management of the sensor firmware update. The retransmission process may be repeated until the bitmap indices of the sensors indicate that all blocks have been successfully received, or until a preset maximum retransmission count limit is reached.

In some embodiments of the present disclosure, by dividing the firmware update package into a plurality of update sub-data blocks and performing selective retransmission based on the first bitmap indices returned by the sensors, efficiency and reliability of large-scale firmware updates of an Internet of Things large-model system under unreliable channels are greatly improved. The solution significantly reduces retransmitted data from the entire firmware package to only individual lost sub-data blocks, thereby improving bandwidth utilization, substantially shortening update delays caused by packet loss, and effectively reducing network load.

In some embodiments, the sensor management platform partitions a plurality of micro-electromagnetic environment clusters based on historical channel data of a plurality of sensor update groups within an industrial grid region. For each of the plurality of micro-electromagnetic environment clusters, the sensor management platform obtains second bitmap indices returned by sensors in the micro-electromagnetic environment cluster, wherein the second bitmap indices reflect second reception states of update sub-data blocks for sensors within a same micro-electromagnetic environment cluster. Then the sensor management platform retransmits one or more of the plurality of update sub-data blocks based on the second bitmap indices returned by the sensors in the plurality of micro-electromagnetic environment clusters.

The historical channel data refers to data describing quality and characteristics of a communication channel during a historical time period. The historical channel data includes a signal-to-noise ratio distribution and an interference pattern.

For example, the signal-to-noise ratio distribution may indicate that a signal-to-noise ratio A accounts for 20% and a signal-to-noise ratio B accounts for 80%. The interference pattern may include periodic pulse interference, bursty continuous interference, or frequency band congestion patterns. The historical time may refer to a time prior to a current moment.

The micro-electromagnetic environment cluster refers to a collection of sensors having similar wireless communication channel environments. Sensors within a same micro-electromagnetic environment cluster have similar wireless communication channel environments.

In some embodiments, the sensor management platform partitions the micro-electromagnetic environment clusters based on the historical channel data.

For example, the sensor management platform may use a clustering algorithm to perform clustering analysis on historical channel data of multiple sensors within an industrial grid region, and automatically classify sensors having similar historical channel data (for example, clean average signal-to-noise ratios, identical interference types, and similar signal strength variances) into a same cluster, wherein each cluster constitutes a micro-electromagnetic environment cluster. By partitioning the micro-electromagnetic environment clusters, sensors having similar wireless communication channel transmission environments can be effectively aggregated.

In another example, the sensor management platform may partition the micro-electromagnetic environment clusters based on a trained machine learning model (for example, a neural network model).

In some embodiments, for each of the plurality of micro-electromagnetic environment clusters, the sensor management platform obtains second bitmap indices returned by sensors in the micro-electromagnetic environment cluster, wherein the second bitmap indices reflect second reception states of update sub-data blocks of the sensors within a same micro-electromagnetic environment cluster.

The second bitmap indices refer to composite bitmap indices reflecting reception states of update sub-data blocks of the sensors within a same micro-electromagnetic environment cluster. For example, the second bitmap indices may be used to reflect the second reception states of all sensors within the same micro-electromagnetic environment cluster with respect to the update sub-data blocks. The second bitmap indices may be a data structure set composed of a plurality of binary bit sequences, including a plurality of binary bit sequences corresponding to the sensors within the micro-electromagnetic environment cluster.

The second reception state refers to reception states of respective update sub-data blocks of the sensors within the same micro-electromagnetic environment cluster.

In some embodiments, the sensor management platform may generate the second bitmap indices based on the reception states of update sub-data blocks of the sensors within the micro-electromagnetic environment cluster.

For example, each sensor generates a first bitmap index representing first reception states of the sensor. The first bitmap indices generated by sensors are then aggregated according to sensor IDs or a predetermined order to form a composite bitmap representing an entire cluster, i.e., a second bitmap index. The aggregation may be performed by concatenating the first bitmap indices of the sensors using logical “AND” or logical “OR” operations.

As another example, the sensor management platform may preset an empty second bitmap index, and transmit query requests to the sensors within the micro-electromagnetic environment cluster to obtain second reception states of the sensors with respect to the update sub-data blocks. The obtained second reception states are filled into corresponding positions of the empty second bitmap index in a one-to-one manner, thereby generating a final second bitmap index.

Each bit of the second bitmap index indicates whether any sensor within the micro-electromagnetic environment cluster has failed to successfully receive a specific update sub-data block.

In some embodiments, the sensor management platform retransmits update sub-data blocks according to the second bitmap index. In some embodiments, the sensor management platform first parses the second bitmap index, identifies bitmap positions set to 0 for at least one sensor within the micro-electromagnetic environment cluster, and forms a cluster-level missing list accordingly.

In some embodiments, the sensor management platform determines, based on bitmap positions in the cluster-level missing list, update sub-data blocks missing from each sensor, obtains and packages the update sub-data blocks, and transmits the same to the entire micro-electromagnetic environment cluster at one time via broadcasting or multicasting. Sensors within the micro-electromagnetic environment cluster that have already successfully received the data blocks may ignore the retransmitted data packets, while sensors that actually lack the update sub-data blocks may complete their data from the broadcast.

In some embodiments of the present disclosure, by dividing the micro-electromagnetic environment clusters and obtaining the second bitmap index reflecting common reception states within each cluster, edge-side collaborative optimization of retransmission is achieved. This approach aggregates a large number of independent sensor retransmission requests into a small number of cluster-level requests, thereby significantly reducing signaling overhead. The sensor management platform performs intra-cluster broadcasting or multicasting of missing data blocks, so that a single transmission can satisfy needs of multiple sensors within the cluster, effectively resolving group packet loss problems caused by local interference.

In some embodiments of the present disclosure, by comprehensively considering the sensor data characteristics, the geographic locations, the task characteristics, the transmission characteristics, the firmware characteristics, and the channel state distribution, sensor update groups, update priorities, and update parameters are accurately determined. The solution achieves effective shaping of update traffic and significantly avoids network congestion. Meanwhile, through intelligent batch-based and time-segmented sequential updating, it ensures that sensors within a same functional region do not fail simultaneously, thereby fundamentally guaranteeing continuity of critical monitoring services. Compared with conventional methods, the present disclosure improves firmware update efficiency while effectively addressing problems of frequent network interruptions and service stagnation in large-scale industrial Internet of Things systems.

FIG. 4 is a schematic flowchart illustrating adjustment of update times of sensor update groups according to some embodiments of the present disclosure. In some embodiments, as shown in FIG. 4, a process 400 may include the following steps:

Step 410: obtaining a plurality of industrial regions.

An industrial region refers to a physical area, divided from a management perspective, that includes industrial grid regions. For example, one industrial region may include a plurality of industrial grid regions for macro-level management.

In some embodiments, the sensor management platform may directly read predefined region information from a regional management configuration database to obtain the plurality of industrial regions.

In some embodiments, the sensor management platform may further obtain the plurality of industrial regions by reading electronic map configurations.

Step 420: determining at least one update test group based on task characteristics, data characteristics, and transmission characteristics of a plurality of sensor update groups within the plurality of industrial regions.

An update test group refers to a subset of sensors that is preferentially selected for performing a small-scale pilot firmware update. For example, the update test group is used to verify compatibility of a firmware update package and stability of an update process before a comprehensive update is performed.

In some embodiments, a manner of determining at least one update test group includes: performing normalization processing and weighting on the task characteristics, the data characteristics, and the transmission characteristics of each sensor update group, and then selecting one or more sensor update groups with highest total scores as the update test group of the industrial region. For further details regarding the task characteristics, the data characteristics, and the transmission characteristics, reference may be made to FIG. 2 and the related description thereof.

In some embodiments, the sensor management platform may further determine the update test group by using a rule engine to filter according to threshold conditions corresponding to the task characteristics, the data characteristics, and the transmission characteristics of each sensor update group.

In some embodiments, the sensor management platform is further configured to: for each of a plurality of micro-electromagnetic environment clusters, determine one or more update test sensors based on sub-task characteristics, sub-data characteristics, and sub-transmission characteristics of sensors within the micro-electromagnetic environment cluster; and determine at least one update test group based on update test sensors corresponding to the plurality of micro-electromagnetic environment clusters.

The sub-data characteristics refer to attributes describing data generation and transmission behaviors of sensors within a micro-electromagnetic environment cluster. For example, if the data characteristics describe overall data acquisition behaviors of multiple sensors within an industrial grid region or an industrial region, the sub-data characteristics may further refine the description to data acquisition frequency of sensors within the micro-electromagnetic environment cluster or a data volume of a single upload.

The sub-transmission characteristics refer to parameters measuring more detailed or localized stability of a sensor communication channel. For example, if the transmission characteristics describe overall stability of sensor channels within an industrial grid region or an industrial region, the sub-transmission characteristics may further refine the description to transmission stability of sensors under a specific micro-electromagnetic environment.

For further details regarding the data characteristics, the transmission characteristics, and the sub-task characteristics, reference may be made to FIG. 2 and the related description thereof.

An update test sensors refers to a sensor within a micro-electromagnetic environment cluster that is selected for performing pilot firmware updates. For example, the update test sensor may be a sensor having optimal transmission characteristics, relatively low task characteristic values, and non-critical data characteristics.

In some embodiments, determining the one or more update test sensors by the sensor management platform includes:

First, the sensor management platform selectS, from all sensors within each micro-electromagnetic environment cluster, sensor(s) whose sub-transmission characteristics satisfy a transmission condition. The transmission condition may include one of: most stable channel, lowest historical packet loss rate, or highest signal-to-noise ratio.

On this basis, the sensor management platform further filters sensor(s) whose sub-task characteristic values satisfy a characteristic condition and whose sub-data characteristics satisfy a data condition (for example, generated data having minimal impact on the system), and determine the filtered sensor(s) as the one or more update test sensors. The characteristic condition may include a task characteristic value being lower than a threshold, and the data condition may include a data acquisition behavior accounting for a smallest proportion of overall data acquisition of the system.

In some embodiments, the sensor management platform determines at least one update test group according to update test sensors corresponding to the plurality of micro-electromagnetic environment clusters.

In some embodiments, determining at least one update test group includes: for each micro-electromagnetic environment cluster, if a plurality of update test sensors are determined within the cluster, taking the plurality of update test sensors as one update test group; and if only one update test sensor is determined within a micro-electromagnetic environment cluster, taking the single update test sensor as an independent update test group.

If there are more than a preset count of micro-electromagnetic environment clusters that each include only one update test sensor, the sensor management platform may determine the update test sensors as a plurality of update test groups according to the manner for determining the plurality of sensor update groups in Step 210.

In some embodiments, the sensor management platform may further group the plurality of update test sensors based on preset business rules or manual configuration by an administrator, thereby determining a plurality of update test groups to satisfy specific testing requirements or resource allocation strategies.

In some embodiments of the present disclosure, by finely considering sub-task characteristics, sub-data characteristics, and sub-transmission characteristics of sensors for each micro-electromagnetic environment cluster to determine update test sensors, and flexibly constructing update test groups based on the sensors, the test groups are enabled to comprehensively cover typical electromagnetic environments and sensor operating states within a region, thereby improving representativeness and accuracy of firmware update testing. This approach effectively avoids risks of misjudgment caused by a single testing environment and ensures that global firmware update decisions are more scientific and reliable.

Step 430: sending the firmware update package to the at least one update test group, and obtaining firmware update statuses of sensors in the at least one update test group.

The firmware update statuses refer to information reflecting status and performance of a firmware update process. For example, the firmware update statuses include firmware-related indicators such as a device restart success rate and a stability of new firmware operation, as well as network-related indicators such as an update duration, a count of retransmissions, and a signal fluctuation during transmission.

In some embodiments, obtaining the firmware update statuses may be implemented by an automated monitoring system that actively collects indicator data from sensors in the update test group. For example, the sensors may actively report indicator data such as the device restart success rate, the stability of new firmware operation, the update duration, the signal fluctuation during transmission, and the count of retransmissions.

In some embodiments, obtaining the firmware update statuses may further be implemented in other manners. For example, a log analysis system may parse log files uploaded by the sensors.

Step 440: adjusting the update times of the plurality of sensor update groups within the plurality of industrial regions according to the firmware update statuses.

In some embodiments, the sensor management platform may adjust the update times according to a predefined adjustment strategy.

For example, when both firmware-related indicators and network-related indicators perform well (e.g., a high device restart success rate, a stable operation of new firmware, a short update duration, and a small count of retransmissions), the sensor management platform may accelerate a subsequent update pace and shorten update time intervals between sensor update groups.

As another example, when network-related indicators are poor (e.g., a long update duration and a large count of retransmissions), indicating network congestion, the sensor management platform may enlarge update time intervals of subsequent update batches.

As yet another example, when firmware-related indicators are poor (e.g., a low device restart success rate and a poor operational stability), indicating defects in the new firmware, the sensor management platform may suspend or cancel updates of subsequent sensor update groups.

In some embodiments, adjustment of the update times may further be dynamically performed according to historical update data and a current network state.

In some embodiments of the present disclosure, by performing updates on small-scale test groups in advance, firmware defects or update strategy issues can be exposed early. Subsequent update plans are dynamically adjusted according to test results, so that the update process has self-optimization capability. This approach significantly improves reliability and security of firmware updates, avoids systemic risks that may be caused by full-scale deployment of defective firmware, and thereby reduces potential production interruptions and operation and maintenance costs.

In some embodiments, a non-transitory computer-readable storage medium storing computer instructions is further provided. When a computer reads the computer instructions from the storage medium, the computer executes the method for sensor remote firmware updating based on a IoT large model described in on or more embodiments of the present disclosure.

The basic concepts have been described above. Obviously, for those skilled in the art, the detailed disclosure above is merely illustrative and does not constitute a limitation on the present disclosure. Although not explicitly stated, those skilled in the art may make various modifications, improvements, and corrections to the present disclosure. Such modifications, improvements, and corrections are suggested within the present disclosure and thus remain within the spirit and scope of the exemplary embodiments of the present disclosure.

Meanwhile, the present disclosure uses specific terms to describe the embodiments herein. Terms such as “one embodiment,” “an embodiment,” and/or “some embodiments” mean that a certain feature, structure, or characteristic related to at least one embodiment of the present disclosure. Therefore, it is emphasized and noted that the terms “an embodiment,” “one embodiment,” or “an alternative embodiment” mentioned two or more times at different locations in the present disclosure do not necessarily refer to the same embodiment. Furthermore, certain features, structures, or characteristics in one or more embodiments of the present disclosure may be appropriately combined.

Furthermore, unless explicitly stated in the claims, the order of processing elements and sequences, the use of numbers or letters, or the use of other names in the present disclosure is not intended to limit the order of the processes and methods described herein. Although the foregoing disclosure discusses some currently considered useful inventive embodiments through various examples, it should be understood that such details are for illustrative purposes only, and the appended claims are not limited to the disclosed embodiments. On the contrary, the claims are intended to cover all modifications and equivalent combinations that conform to the essence and scope of the embodiments of the present disclosure. For example, although the system components described above may be implemented via hardware devices, they may also be realized solely through software solutions, such as installing the described system on existing servers or mobile devices.

Similarly, it should be noted that to simplify the presentation of the present disclosure and thereby aid in understanding one or more inventive embodiments, in the descriptions of the embodiments of the present disclosure above, various features may sometimes be grouped into a single embodiment, figure, or description thereof. However, this disclosure manner does not imply that the subject matter of the present disclosure requires more features than those mentioned in the claims. In fact, the features of an embodiment are fewer than all the features of a single embodiment disclosed above.

In some embodiments, numbers describing quantities or attributes are used. It should be understood that such numbers used in the description of the embodiments may, in some examples, be modified by the terms “approximately,” “about,” or “substantially.” Unless otherwise specified, “approximately,” “about,” or “substantially” indicates that the stated number allows for a variation of ±20%. Accordingly, in some embodiments, the numerical parameters used in the specification and claims are approximations, which may vary depending on the characteristics required by individual embodiments. In some embodiments, numerical parameters should consider the specified number of significant digits and adopt the method of general digit retention. Although the numerical ranges and parameters used to confirm their breadth in some embodiments of the present disclosure are approximations, in specific embodiments, such numerical values are set as accurately as possible within the feasible range.

For each patent, patent application, patent application publication, and other material, such as articles, books, specifications, publications, documents, etc., cited in the present disclosure, the entire content thereof is hereby incorporated by reference into the present disclosure. Excluded are application history documents that are inconsistent or conflict with the content of the present disclosure, and documents that limit the broadest scope of the claims of the present disclosure (whether currently or subsequently appended to the present disclosure). It should be noted that if the description, definition, and/or use of terms in the supplementary materials of the present disclosure are inconsistent or conflict with those in the present disclosure, the description, definition, and/or use of terms in the present disclosure shall prevail.

Finally, it should be understood that the embodiments described in the present disclosure are merely illustrative of the principles of the embodiments of the present disclosure. Other variations may also fall within the scope of the present disclosure. Therefore, by way of example and not limitation, alternative configurations of the embodiments of the present disclosure may be considered consistent with the teachings of the present disclosure. Accordingly, the embodiments of the present disclosure are not limited to those explicitly introduced and described herein.

What is claimed is:

1. A system for sensor remote firmware updating based on an Internet of Things (IoT) large model, comprising:
a sensor management platform,
wherein the sensor management platform is configured to:
determine a plurality of sensor update groups according to data characteristics of a plurality of sensors and geographic locations of the plurality of sensors in an industrial grid region;
determine an update priority of each of the plurality of sensor update groups according to task characteristics and transmission characteristics of the plurality of sensor update groups;
determine update parameters of the plurality of sensor update groups according to the update priority, firmware characteristics, and a channel state distribution;
generate update instructions and a firmware update package according to the update parameters, wherein the update instructions include an update time; and
send the update instructions and the firmware update package to a perception control platform, and control the plurality of sensors in the plurality of sensor update groups to perform firmware updating based on the update instructions.

2. The system of claim 1, wherein the sensor management platform is further configured to:
determine association degrees among the plurality of sensors based on the data characteristics and subtask characteristics of the plurality of sensors; and
adjust the plurality of sensor update groups based on the association degrees.

3. The system of claim 1, wherein the sensor management platform is further configured to:
divide the firmware update package into a plurality of update sub-data blocks according to a preset unit size, and send the plurality of update sub-data blocks to the perception control platform;
transmit, via the perception control platform, the plurality of update sub-data blocks to the plurality of sensors;
obtain first bitmap indices returned by the plurality of sensors, wherein each of the first bitmap indices reflects first reception states of the plurality of update sub-data blocks for a corresponding sensor; and
retransmit one or more of the plurality of update sub-data blocks to at least one of the plurality of sensors based on the first bitmap indices.

4. The system of claim 3, wherein the sensor management platform is further configured to:
partition a plurality of micro-electromagnetic environment clusters based on historical channel data of the plurality of sensor update groups within the industrial grid region;
for each of the plurality of micro-electromagnetic environment clusters:
obtain a second bitmap index returned by sensors in the micro-electromagnetic environment cluster, wherein the second bitmap index reflects second reception states of update sub-data blocks for sensors within a same micro-electromagnetic environment cluster; and
retransmit one or more of the plurality of update sub-data blocks based on second bitmap indices returned by the sensors in the plurality of micro-electromagnetic environment clusters.

5. The system of claim 3, wherein the sensor management platform is further configured to:
for each of the plurality of update sub-data blocks:
determine a check code based on the update sub-data block using a preset verification algorithm;
generate a sub-update package according to the update sub-data block and the check code; and
send a plurality of sub-update packages corresponding to the plurality of update sub-data blocks to the perception control platform, wherein the plurality of sub-update packages are used to determine the first bitmap indices.

6. The system of claim 1, wherein the sensor management platform is further configured to:
obtain a plurality of industrial regions;
determine at least one update test group based on the task characteristics, the data characteristics, and the transmission characteristics of the plurality of sensor update groups within the plurality of industrial regions;
send the firmware update package to the at least one update test group, and obtain firmware update statuses of sensors in the at least one update test group; and
adjust update times of the plurality of sensor update groups within the plurality of industrial regions according to the firmware update statuses.

7. The system of claim 6, wherein the sensor management platform is further configured to:
for each of a plurality of micro-electromagnetic environment clusters, determine one or more update test sensors based on subtask characteristics, sub-data characteristics, and sub-transmission characteristics of sensors within the micro-electromagnetic environment cluster; and
determine the at least one update test group based on update test sensors corresponding to the plurality of micro-electromagnetic environment clusters.

8. The system of claim 1, further comprising a sensor network platform and the perception control platform, wherein
the sensor network platform is configured to perform data interaction with the sensor management platform and the perception control platform, respectively.

9. The system of claim 8, wherein the sensor management platform includes a data center, and the sensor management platform performs data interaction with the sensor network platform through the data center.

10. A method for sensor remote firmware updating based on an Internet of Things (IoT) large model, implemented by a sensor management platform of a system for sensor remote firmware updating based on the IoT large model, the method comprising:
determining a plurality of sensor update groups according to data characteristics of a plurality of sensors and geographic locations of the plurality of sensors in an industrial grid region;
determining an update priority of each of the plurality of sensor update groups according to task characteristics and transmission characteristics of the plurality of sensor update groups;
determining update parameters of the plurality of sensor update groups according to the update priority, firmware characteristics, and a channel state distribution;
generating update instructions and a firmware update package according to the update parameters, wherein the update instructions include an update time; and
sending the update instructions and the firmware update package to a perception control platform, and controlling the plurality of sensors in the plurality of sensor update groups to perform firmware updating based on the update instructions.

11. The method of claim 10, further comprising:
determining association degrees among the plurality of sensors based on the data characteristics and subtask characteristics of the plurality of sensors; and
adjusting the plurality of sensor update groups based on the association degrees.

12. The method of claim 10, wherein the sending the update instructions and the firmware update package to a perception control platform, and controlling the plurality of sensors in the plurality of sensor update groups to perform firmware updating based on the update instructions includes:
dividing the firmware update package into a plurality of update sub-data blocks according to a preset unit size, and sending the plurality of update sub-data blocks to the perception control platform;
transmitting, via the perception control platform, the plurality of update sub-data blocks to the plurality of sensors;
obtaining first bitmap indices returned by the plurality of sensors, wherein each of the first bitmap indices reflects first reception states of the plurality of update sub-data blocks for a corresponding sensor; and
retransmitting one or more of the plurality of update sub-data blocks to at least one of the plurality of sensors based on the first bitmap indices.

13. The method of claim 12, wherein the sending the update instructions and the firmware update package to a perception control platform, and controlling the plurality of sensors in the plurality of sensor update groups to perform firmware updating based on the update instructions includes:
partitioning a plurality of micro-electromagnetic environment clusters based on historical channel data of the plurality of sensor update groups within the industrial grid region;
for each of the plurality of micro-electromagnetic environment clusters:
obtaining a second bitmap index returned by sensors in the micro-electromagnetic environment cluster, wherein the second bitmap index reflects second reception states of update sub-data blocks for sensors within a same micro-electromagnetic environment cluster; and
retransmitting one or more of the plurality of update sub-data blocks based on second bitmap indices returned by the sensors in the plurality of micro-electromagnetic environment clusters.

14. The method of claim 12, further comprising:
for each of the plurality of update sub-data blocks:
determining a check code based on the update sub-data block using a preset verification algorithm;
generating a sub-update package according to the update sub-data block and the check code; and
sending a plurality of sub-update packages corresponding to the plurality of update sub-data blocks to the perception control platform, wherein the plurality of sub-update packages are used to determine the first bitmap indices.

15. The method of claim 10, further comprising:
obtaining a plurality of industrial regions;
determining at least one update test group based on the task characteristics, the data characteristics, and the transmission characteristics of the plurality of sensor update groups within the plurality of industrial regions;
sending the firmware update package to the at least one update test group, and obtaining firmware update statuses of sensors in the at least one update test group; and
adjusting update times of the plurality of sensor update groups within the plurality of industrial regions according to the firmware update statuses.

16. The method of claim 15, wherein the determining at least one update test group based on the task characteristics, the data characteristics, and the transmission characteristics of the plurality of sensor update groups within the plurality of industrial regions includes:
for each of a plurality of micro-electromagnetic environment clusters, determining one or more update test sensors based on subtask characteristics, sub-data characteristics, and sub-transmission characteristics of sensors within the micro-electromagnetic environment cluster; and
determining the at least one update test group based on update test sensors corresponding to the plurality of micro-electromagnetic environment clusters.

17. The method of claim 10, wherein the system for sensor remote firmware updating based on the IoT large model further comprises a sensor network platform and the perception control platform, wherein
the sensor network platform is configured to perform data interaction with the sensor management platform and the perception control platform, respectively.

18. The method of claim 17, wherein the sensor management platform includes a data center, and the sensor management platform performs data interaction with the sensor network platform through the data center.

19. A non-transitory computer-readable storage medium, storing computer instructions, wherein when reading the computer instructions stored in the storage medium, a computer executes a method for sensor remote firmware updating based on an Internet of Things (IoT) large model, the method comprising:
determining a plurality of sensor update groups according to data characteristics of a plurality of sensors and geographic locations of the plurality of sensors in an industrial grid region;
determining an update priority of each of the plurality of sensor update groups according to task characteristics and transmission characteristics of the plurality of sensor update groups;
determining update parameters of the plurality of sensor update groups according to the update priority, firmware characteristics, and a channel state distribution;
generating update instructions and a firmware update package according to the update parameters, wherein the update instructions includes an update time; and
sending the update instructions and the firmware update package to a perception control platform, and controlling the plurality of sensors in the plurality of sensor update groups to perform firmware updating based on the update instructions.
